(19) United States
(12) Patent Application Publication
(10) Pub. No.: US 2023/0279269 A1
(43) Pub. Date: Sep. 7, 2023

(54) HIGHLY-TENSILE KRAFT ADHESIVE PAPER TAPE AND MANUFACTURING PROCESS THEREOF

(71) Applicant: Fujian Jialong Tape Co.,Ltd., Zhangzhou (CN)

(72) Inventor: Benyu HUANG, Ningde (CN)

(73) Assignee: Fujian Jialong Tape Co.,Ltd., Zhangzhou (CN)

(21) Appl. No.: 17/834,950

(22) Filed: Jun. 8, 2022

(30) Foreign Application Priority Data
Mar. 3, 2022 (CN) 2022102005979

(51) Int. Cl. C09J 7/21; C09J 7/29; C09J 103/02

(52) U.S. Cl. CPC C09J 7/21; C09J 7/29; C09J 103/02; C09J 2400/283; C09J 2301/122; C09J 2403/006

(57) ABSTRACT

The invention provides a highly-tensile kraft paper adhesive tape and a manufacturing process thereof. The adhesive tape includes a kraft paper layer, a plurality of yarn layers, a kraft paper layer and glue layers, which are fixedly connected in sequence; the specific number of layers of the plurality of yarn layers can be multi-layered according to actual situations, and the two adjacent yarn layers, and each kraft paper layer and the corresponding yarn layer, are fixedly connected by adhesion layers. Yarns in the yarn layers are classified into warp yarns and weft yarns, which are distributed crosswise. The tensile strength of the adhesive tape can be effectively improved by providing the two kraft paper layers to form a matrix of the adhesive tape. A plurality of yarn layers are provided between the two kraft paper layers to improve the structural stability of the moisture-permeable and water-proof adhesive tape.

### CROSS-REFERENCE TO RELATED APPLICATIONS

The application claims priority to Chinese patent application No. 2022102005979, filed on Mar. 3, 2022, the entire contents of which are incorporated herein by reference.

### TECHNICAL FIELD

The present invention relates to the field of adhesive tapes, in particular to a highly-tensile kraft paper adhesive tape and a manufacturing process thereof.

### BACKGROUND

An adhesive tape has the characteristics that: it can be easily adhered in the presence of a small pressure, can take an adhesion effect in a short time, does not contaminate an adherend after peeling, and can be re-corrected in the case of wrong pasting. Taking a kraft paper adhesive tape as an example, the kraft paper adhesive tape takes kraft paper as a base material, which is coated with glue on one side to form an adhesive tape with high viscosity. However, the current kraft paper adhesive tape is generally poor in tear resistance, as a result of a relatively simple structure of the current kraft paper adhesive tape.

### SUMMARY

In view of the defects proposed in the above-mentioned background art, the present invention provides a highly-tensile kraft adhesive paper tape and a manufacturing process thereof.

The present invention adopts the following technical solutions.

A highly-tensile kraft paper adhesive tape is characterized by including a kraft paper layer, a plurality of yarn layers, a kraft paper layer and glue layers, which are fixed connected in sequence, wherein

among the plurality of yarn layers, the respective yarn layers are laminated in sequence and arranged between the two kraft paper layers; and yarns in the yarn layers are classified into warp yarns and weft yarns, which are distributed crosswise, such that an array of diamond-shaped meshes is formed in each yarn layer.

As an improvement of the above-mentioned adhesive tape, in each of the yarn layers, within a distance of 10 mm 1 to 10 warp yarns and 1 to 10 weft yarns are disposed respectively.

As an improvement of the above-mentioned adhesive tape, each kraft paper adhesive layer has a specification of 20-300 g/m².

As an improvement of the above-mentioned adhesive tape, each glue layer has a coating weight of 5-100 g/m².

A manufacturing process of the highly-tensile kraft adhesive paper tape includes the following steps:
enabling the respective kraft paper layers and the respective yarn layers to pass through two heat-conducting rollers of compounding equipment respectively and then connecting to drawing equipment, and providing the kraft paper layer, the plurality of yarn layers and the kraft paper layer in sequence in a gap between the two heat-conducting rollers of the compounding equipment from bottom to top; and meanwhile, enabling the respective yarn layers to pass over a flat plate before entering the compounding equipment, and drawing the lower kraft paper layer to move in parallel under the flat plate; and the process of drawing the respective kraft paper layers and respective yarn layers to move includes the following steps:
S1: when the respective yarn layers are drawn to move onto the flat plate, coating the surfaces of the yarn layers with composite glue; and when the yarn layers coated with the composite glue move out of the flat plate. i.e., laminated on the lower kraft paper layer, drawing the respective yarn layers to move between the two kraft paper layers;
S2: when the respective yarn layers are drawn to move between the two kraft paper layers, but not drawn to the compounding equipment, preheating at a preheating temperature of 30 to 200° C.;
S3: when the respective kraft paper layers and respective yarn layers move to the compounding equipment, heating the composite glue of the yarn layers by using the two heat-conducting rollers of the compounding equipment; and meanwhile, pressing and compounding the kraft paper layers and the yarn layers by using the two heat-conducting rollers, such that the kraft paper layers and the yarn layers are adhered in sequence by the composite glue to form the kraft paper layer, the plurality of yarn layers and the kraft paper layer that are fixed and adhered in sequence;
S4: after the respective kraft paper layers and respective yarn layers pass through the two heat-conducting rollers of the compounding equipment, coating the upper surface of the upper kraft paper layer with starch glue, the starch glue being used to form the glue layers; and
S5: drying and rolling the formed glue layers coated with the starch glue, thereby obtaining a fully-degradable single-layer moisture-permeable and water-proof adhesive tape with high tear resistance.

As a further improvement of the above-mentioned process, a speed at which the kraft paper layers and the yarn layers are drawn to move is 10-300 m/min.

As a further improvement of the above-mentioned process, in step S1, the respective yarn layers are drawn vertically downwards or vertically upwards, and then bypass guide rollers and are horizontally drawn to the flat plate to form a state of laminated movement; and among the plurality of yarn layers moving horizontally on the flat plate, a position of the upper yarn layer that is coated with the composite glue is closer to the compounding equipment than a position of the lower yarn layer that is coated with the composite glue.

As can be seen from the above description of the present invention, compared with the prior art, the present invention has the following advantages: the tensile strength of the adhesive tape can be effectively improved by providing the two kraft paper layers so as to form a matrix of the adhesive tape. In addition, according to the present invention, the plurality of yarn layers are provided between the two kraft paper layers, which can improve the structural stability of the moisture-permeable and water-proof adhesive tape and make it difficult to deform. In summary, the kraft paper adhesive tape of the present invention has a firm structure and can resist higher strength tearing than the current kraft paper adhesive tape.

### BRIEF DESCRIPTION OF DRAWINGS

FIG. 1 is a schematic sectional view of a kraft paper adhesive tape of the present invention.

FIG. 2 is a top view when a yarn layer is laminated on a kraft paper layer.

FIG. 3 is a top view when yarns in the yarn layer are distributed in an “S” shape.

FIG. 4 is a top view when yarns in the yarn layer are distributed in a straight line.

FIG. 5 is a schematic diagram of a drawing and compounding process of the kraft paper adhesive tape of the present invention.

### DETAILED DESCRIPTION OF THE EMBODIMENTS

The specific embodiments of the present invention are further described below by reference to the accompanying drawings.

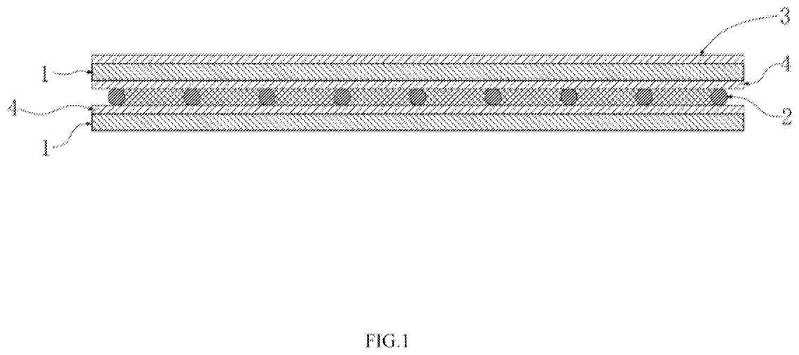

As shown in FIG. 1, a highly-tensile kraft paper adhesive tape includes a kraft paper layer 1, a plurality of yarn layers 2, a kraft paper layer 1 and glue layers 3, which are fixedly connected in sequence, wherein the two adjacent yarn layers 2, and each kraft paper layer 1 and the corresponding yarn layer 2, are fixedly connected by adhesive layers 4.

The kraft paper layer 1 is made of kraft paper, and a specification of 20-300 g/m² may be selected according to actual strength requirements.

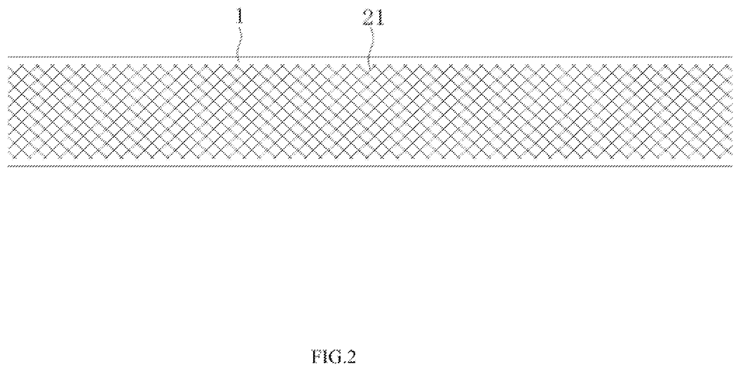

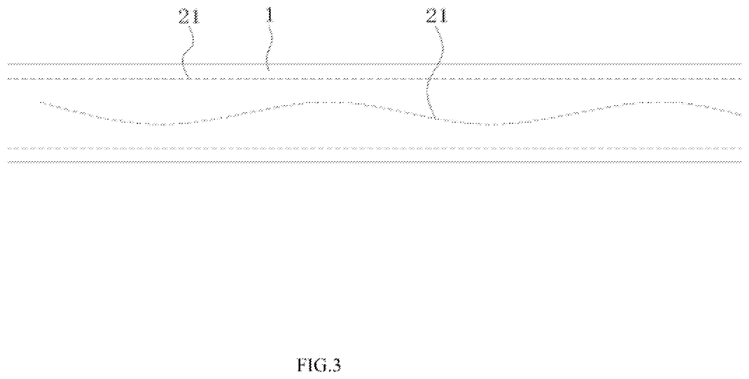

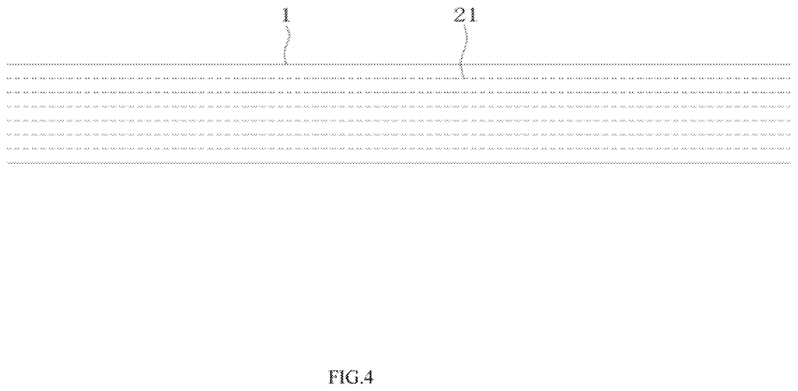

Each of the yarn layers 2 is formed by weaving yarns, wherein the yarns may be made of glass fiber yarns, chemical fiber yarns, nylon yarns or the like. Referring to FIG. 2 again, the yarns 21 in the yarn layer 2 are classified into warp yarns and weft yarns, and within a distance of 10 mm 1 to 10 warp yarns and 1 to 10 weft yarns are disposed respectively. Meanwhile, the warp yarns and the weft yarns are distributed crosswise to form a shape in an array of a plurality of diamond-shaped meshes in FIG. 2. The distribution structure of the yarns 21 can simultaneously improve the transverse and longitudinal tearing strength of the kraft paper adhesive tape, and at the same time make it difficult to break. In addition, the yarns 21 may also be distributed in parallel along a length extension direction of the kraft paper layers 1 as shown in FIG. 3, or distributed in an S-shaped bend along the length extension direction of the kraft paper layers 2 as shown in FIG. 4. The distribution structure of the yarns 21 can also improve the tear resistance of the kraft paper adhesive tape, and at the same time make it difficult to break, which is beneficial to prolong the service life of the kraft paper adhesive tape.

The specific number of layers of the plurality of yarn layers 2 may be multi-layered according to actual situations, and the respective yarn layers 2 are sequentially laminated between the two kraft paper layers 1. In addition, the adhesive layers 4 between the two adjacent yarn layers 2 and between each yarn layer 2 and the corresponding kraft paper layer 1 may be composite glue, so that they are fixed by composite adhesion of the composite glue. Therefore, the respective yarn layers 2 are connected to the two kraft paper layers 1 to form a main body structure of the present invention. The strength, i.e., the tensile strength, of the adhesive tape can be further improved by providing the two kraft paper layers 1.

The glue layers 3 are used for an adhesion purpose, and may be starch glue. The composite glue forming the adhesive layers 4 may be hot melt glue or EVA glue, and auxiliary agents such as a photocatalyst and a defoamer may be added to the composite glue. After absorbing light energy, the photocatalyst can directly be used for a redox reaction of an object adsorbed on the surface, thereby promoting the degradation of the kraft paper adhesive tape of the present invention. Meanwhile, the yarns 21 of the yarn layers 2 can also effectively ensure the light transmittance of the kraft paper layers 1 due to a crossed structure of the warp yarns and the weft yarns, thereby further promoting the redox reaction of the photocatalyst, that is, the degradation efficiency.

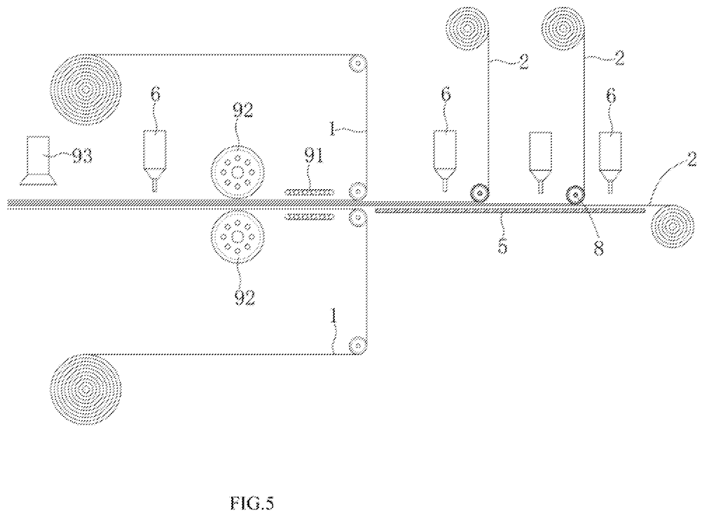

As shown in FIG. 5, a manufacturing process of the highly-tensile kraft adhesive paper tape includes the following steps:

enabling the respective kraft paper layers 1 and the respective yarn layers 2 to pass through two heat-conducting rollers 9 of compounding equipment respectively and then connecting to drawing equipment (not shown), and providing the kraft paper layer 1, the plurality of yarn layers 2 and the kraft paper layer 1 in sequence in a gap between the two heat-conducting rollers 9 of the compounding equipment from bottom to top; and meanwhile, enabling the respective yarn layers 2 to pass over a flat plate 5 before entering the compounding equipment, such that the yarn layers 2 are conveyed on the flat plate 5 before entering the compounding equipment; and drawing the lower kraft paper layer 1 to move in parallel under the flat plate 5. The process of drawing the respective kraft paper layers 1 and respective yarn layers 2 to move includes the following steps S1 to S5.

In S1, the yarn layers 2 move on the flat plate 5 before entering the compounding equipment, the surfaces of the yarn layers 2 on the flat plate 5 are coated with composite glue, and the coated composite glue has a distance from the boundary of each yarn layer 2, which can prevent the composite glue from overflowing after the kraft paper layers 1 and the yarn layers 2 are compounded. This coating manner of the composite glue can make respective diamond-shaped meshes in each yarn layer 2 be filled with an adhesive material (i.e., the composite glue), in order to improve the firmness level of the subsequent yarn layer 2 and the kraft paper layer 1 after being adhered. Meanwhile, a speed at which the kraft paper layers 1 and the yarn layers 2 are drawn to move is 10-300 m/min. This speed ensures that the filled composite glue can be drawn to move in the respective diamond-shaped meshes of the yarn layers 2, so as to avoid the adhesion failure of the composite glue due to the excessively fast moving speed.

Further, in the case of a plurality of the yarn layers 2, each of the yarn layers 2 is drawn vertically downward or vertically upward and then bypasses guide rollers 8 and is horizontally drawn onto the flat plate 5 to form a state of laminated movement. The guide rollers 8 for drawing the respective yarn layers 2 are arranged in sequence along a moving direction of the yarn layers 2, and the positions, coated with the composite glue, of the plurality of yarn layers 2 that moves on the flat plate 5 are all located behind the guide rollers 8 respectively. That is, the yarn layers 2 first bypass the guide rollers 8 and are then coated with the composite glue, and meanwhile, a position of the upper yarn layer 2 where a coating machine 6 is disposed is closer to the compounding equipment than a position of the lower yarn layer 2 where a coating machine 6 is disposed, in this way, the respective yarn layers 2 can be embedded in a layer of composite glue, respectively. In addition, when the respective yarn layers 2 are coated with the composite glue and then drawn to move on the flat plate 5, the composite glue coated on the respective yarn layers 2 can be fused with each other, such that the respective yarn layers 2 are laminated and adhered to form an integral body.

The lower kraft paper layer 1 moves horizontally under the flat plate 5, and is connected to the lower side at the end of the flat plate 5. This structure makes the yarn layer 2 coated with the composite glue move out of the flat plate 5 and then laminated on the lower kraft paper layer 1.

In addition, the flat plate 5 may be provided with baffles (not shown) that are bent upward and disposed on both sides of the yarn layer 2 in a conveying direction. The baffles are used to block the composite glue and prevent the composite glue from flowing out to both sides. Meanwhile, a receiving groove (not shown) may also be provided under the flat plate 5 and used to receive a small amount of composite glue overflowing downward from the front and rear ends of the flat plate 5 in the conveying direction of the yarn layer 2, so as to facilitate recycling.

In S2, when the respective yarn layers 2 are drawn to move between the two kraft paper layers 1, but not drawn to the compounding equipment, the respective yarn layers 2 are preheated at a preheating temperature of 30 to 200° C. In this preheating method, an electric heating tube 91 may be respectively disposed above the upper kraft paper layer 1 and under the lower kraft paper layer 1, so as to form a high-temperature environment to preheat the composite glue on the yarn layers 2 between the two kraft paper layers 1, such that the composite adhesive tends to be gelatinized, which avoids the adhesion failure of the composite glue when entering the compounding equipment.

In S3, when the respective kraft paper layers 1 and respective yarn layers 2 move to the compounding equipment, the composite glue of the respective yarn layers is heated by using two heat-conducting rollers 92 of the compounding equipment; and meanwhile, the kraft paper layers 1 and the yarn layers 2 are pressed and compounded by using the two heat-conducting rollers 9 of the compounding equipment, such that the composite glue coated on the yarn layers 2 forms adhesive layers 4 for adhering the two adjacent yarn layers 2, as well as each yarn layer 2 and the corresponding kraft paper layer 1, thereby forming the kraft paper layer 1, the plurality of yarn layers 2 and the kraft paper layer 1 which are fixedly adhered in sequence.

In S5, after the respective kraft paper layers and respective yarn layers pass through the compounding equipment, the upper surface of the upper kraft paper layer 1 is coated with starch glue, the starch glue being used to form the glue layers 3. It is worth mentioning that the coating methods in this embodiment may all be operated by the coating machine 6.

In S6: the formed glue layers 3 coated with the starch glue are dried and rolled, thereby obtaining a fully-degradable single-layer moisture-permeable and water-proof adhesive tape with high tear resistance. For a specific drying method, a hot air blower 93 may be used to blow hot air upward from the lower kraft paper layer 1 so as to promote the curing of the starch glue, wherein the temperature of the hot air is 32 to 40° C.

It can be seen from the above process that the one-time composite molding of the plurality of kraft paper layers 1 and the respective yarn layers 2 can be completed by drawing the respective kraft paper layers 1 and the respective yarn layers 2 to pass through respective procedures in the composite molding process of the kraft paper adhesive tape, without moving to another location for secondary processing, which is very simple and helps to improve the production efficiency of the kraft paper adhesive tape of the present invention.

The above content is only specific embodiments of the present invention, but the design concept of the present invention is not limited to this, and any non-substantial modification of the present invention using this concept shall be regarded as an act infringing the protection scope of the present invention.

What is claimed is:

1. A highly-tensile kraft paper adhesive tape, comprising a kraft paper layer, a plurality of yarn layers, a kraft paper layer and glue layers, wherein
among the plurality of yarn layers, the respective yarn layers are laminated in sequence and arranged between the two kraft paper layers; and yarns in the yarn layers are classified into warp yarns and weft yarns, which are distributed crosswise, such that an array of diamond-shaped meshes is formed in each yarn layer.

2. The highly-tensile kraft paper adhesive tape according to claim 1, wherein in each of the yarn layers, within a distance of 10 mm 1 to 10 warp yarns and 1 to 10 weft yarns are disposed respectively.

3. The highly-tensile kraft paper adhesive tape according to claim 1, wherein the kraft paper adhesive layer has a specification of 20-300 g/m².

4. The highly-tensile kraft paper adhesive tape according to claim 1, wherein the glue layer has a coating weight of 5-100 g/m².

5. A manufacturing method for the highly-tensile kraft paper adhesive tape according to claim 1, the process comprising:
enabling the respective kraft paper layers and the respective yarn layers to pass through two heat-conducting rollers of compounding equipment respectively and then connecting to drawing equipment, and providing the kraft paper layer, the plurality of yarn layers and the kraft paper layer in sequence in a gap between the two heat-conducting rollers of the compounding equipment from bottom to top; and meanwhile, enabling the respective yarn layers to pass over a flat plate before entering the compounding equipment, and drawing the lower kraft paper layer to move in parallel under the flat plate; and the process of drawing the respective kraft paper layers and respective yarn layers to move comprises the following steps:
S1: when the respective yarn layers are drawn to move onto the flat plate, coating the surfaces of the yarn layers with composite glue; and when the yarn layers coated with composite glue move out of the flat plate, i.e., laminated on the lower kraft paper layer, drawing the yarn layers to move between the two kraft paper layers;
S2: when the respective yarn layers are drawn to move between the two kraft paper layers, but not drawn to the compounding equipment, preheating at a preheating temperature of 30 to 200° C.;
S3: when the respective kraft paper layers and respective yarn layers move to the compounding equipment, heating the composite glue of the yarn layers by using the two heat-conducting rollers of the compounding equipment; and meanwhile, pressing and compounding the kraft paper layers and the yarn layers by using the two heat-conducting rollers, such that the kraft paper layers and the yarn layers are adhered in sequence by the composite glue to form the kraft paper layer, the plurality of yarn layers and the kraft paper layer that are fixed and adhered in sequence;
S4: after the respective kraft paper layers and respective yarn layers pass through the two heat-conducting rollers of the compounding equipment, coating the upper surface of the upper kraft paper layer with starch glue, the starch glue being used to form the glue layers; and
S5: drying and rolling the formed glue layers coated with the starch glue, thereby obtaining a fully-degradable single-layer moisture-permeable and water-proof adhesive tape with high tear resistance.

6. The highly-tensile kraft paper adhesive tape according to claim 5, wherein a speed at which the kraft paper layers and the yarn layers are drawn to move is 10-300 m/min.

7. The highly-tensile kraft paper adhesive tape according to claim 5, wherein in step S1, the respective yarn layers are drawn vertically downwards or vertically upwards, and then bypass guide rollers and are horizontally drawn to the flat plate to form a state of laminated movement; and among the plurality of yarn layers moving horizontally on the flat plate, a position of the upper yarn layer that is coated with the composite glue is closer to the compounding equipment than a position of the lower yarn layer that is coated with the composite glue.
